(19) United States
(12) Patent Application Publication
(10) Pub. No.: US 2012/0232974 A1
(43) Pub. Date: Sep. 13, 2012

(54) System and Method of Distributing a Coupon

(76) Inventor: Tony Castiglione, (US)

(21) Appl. No.: 13/044,908

(22) Filed: Mar. 10, 2011

(51) Int. Cl. G06Q 30/00

(52) U.S. Cl. 705/14.21

(57) ABSTRACT

A method and system of distributing a coupon in response to a request from a user using a computer network is disclosed. A database is maintained having one or more coupon records associated with one or more advertisers, wherein each coupon record is associated with an advertiser credit account. A coupon request is received from an indicating user for a coupon associated with a coupon record in the database via the computer network. The system provides to the indicating user a coupon corresponding to the coupon request via the computer network. The system subtracts a coupon distribution amount from the advertiser credit account associated with the coupon provided. The system may optionally subtract a coupon redemption amount from the advertiser credit account associated with the coupon when the coupon is redeemed or after the coupon is redeemed.

### FIELD OF THE INVENTION

This invention relates in general to advertising system, in particular to network coupon distribution systems.

### BACKGROUND OF THE INVENTION

Businesses and other entities have long sought to incentivize consumers and clients to purchase the offered goods and services. Further entities have sought to increase exposure to particular causes, such as charitable causes. One method to incentivize the sale or use of an entities goods or services is to provide the consumer or client with a discount for those goods and services. Further, in certain circumstances a business or entity may benefit by discounting, including by giving away without charge, one good or service to gain customer exposure to one or more other goods or services provided by that business or another associated entity. In addition, a business or entity might discount a good or service to generate goodwill or exposure within a particular client or customer base, which may benefit the business or entity.

The availability of the Internet has brought new avenues for advertising and for tracking return on advertising expenditures. U.S. Pat. No. 6,269,361 discloses a method which debits an advertiser's account that is associated with an advertiser's paid search listing when a user clicks on the advertiser's paid search listing and is directed to a URL defined by the advertiser. The method of the '361 patent may be known as a pay-per-click system. However, the '361 patent art pay-per-click system do not enable a user to distribute a discount or coupon to a group of recipients designated by the user.

The present inventor recognizes the need for a system that allows users to search for coupons redeemable within a particular geographic area.

The inventor recognizes a need for a system that allows users to organize a meeting at a location and provide coupons to the meeting participants, which are redeemable at or about the location of the meeting.

The inventor recognizes a need for a system that closely ties advertiser costs to users indicating an interest in the goods or services provided in a particular location or to recipients likely to be located at or about a location where the advertiser's goods or services are offered.

The inventor recognizes a need for a system that assesses a charge to an advertiser on a per-coupon-push basis.

The inventor recognizes a need for a system that assesses a charge to an advertiser on a per-coupon-redemption basis.

The inventor recognizes a need for a system that provides coupons to recipients where those coupons can be displayed by the user or recipient on a mobile electronic device at the location of redemption and to be redeemed from the mobile device.

The inventor recognizes a need for a system that enables users to be advocates for advertisers—when the user finds value in the advertiser's offering(s)—to the user's friends and associates. Further, the inventor recognizes a need for a system that rewards users that connect recipients with coupons of an advertiser when those coupons are redeemed by the recipient.

### SUMMARY OF THE INVENTION

A method and system of distributing a coupon in response to a request from a user using a computer network is disclosed. A database is maintained having one or more coupon records associated with one or more advertisers, wherein each coupon record is associated with an advertiser credit account. A coupon request is received from an indicating user for a coupon associated with a coupon record in the database via the computer network. The system provides to the indicating user with a coupon corresponding to the coupon request via the computer network. The system subtracts a coupon distribution amount from the advertiser credit account associated with the coupon provided.

In one embodiment, the coupon record is associated with a location value and the system receives indicating user location information from the indicating user. The system queries the database to retrieve a coupon result set of coupon records associated with a location value representing a geographic location within a predefined distance from the geographic location represented by the indicating user location information. The system provides the coupon result set to the indicating user. The system receives a selection, from the user, of one or more coupons of the coupon result set.

In one embodiment, the user location information is one of GPS information, street address information, or business location information.

In one embodiment, the system requests location information from a location-aware device of the indicating user.

In one embodiment, the system distributes a coupon to one or more recipients, such as a group of recipients designated by the indicating user. In one embodiment, the system calculates a total coupon-push-cost by multiplying the number of recipients by a pre-defined unit coupon price, and the coupon distribution amount debited from the advertisers account is the total coupon-push-cost.

In one embodiment, the system only provides the coupon to the recipients if the total coupon-push-cost is less than or equal to the advertiser credit account balance.

In one embodiment, the system subtracts a coupon redemption amount from the advertiser credit account associated with the coupon when the coupon is redeemed or after the coupon is redeemed.

In one embodiment, the system has a computer system with a database having at least one account record for each of a plurality of advertisers using the computer network. The account record has at least one coupon record having a coupon and a coupon identifier, and an account balance. The account record also has a payment history, and payment processing information, wherein said payment processing information is accessible to the computer system and isolated from public access via the computer network.

In one embodiment, the system has an authentication function for providing the advertiser with login access in response to authentication, wherein the advertiser's login access grants the advertiser access to modify the advertiser's account, the advertiser not being provided with access to modify the accounts of others.

In one embodiment, the system has an add coupon function for adding a coupon to an account of an advertiser upon receiving a request from the advertiser.

In one embodiment, the system has a coupon deactivation function for deactivating a coupon related to an account of an advertiser in substantially real time upon receiving a request from said advertiser.

In one embodiment, the system has a request receiving function for receiving a coupon request from an indicating user for a coupon associated with a coupon record in the database, the coupon request being received over the computer network from a remote computer through a home page that is publicly accessible without authentication.

In one embodiment, the system has a coupon distribution function for distributing the coupon corresponding to the coupon request of the indicating user over the computer network.

In one embodiment, the system has an account debit function for subtracting a coupon distribution amount from the account balance of the advertising user associated with the distributed coupon.

Numerous other advantages and features of the present invention will be become readily apparent from the following detailed description of the invention and the embodiments thereof, from the claims, and from the accompanying drawings.

### BRIEF DESCRIPTION OF THE DRAWINGS

FIG. 1 is a diagrammatical view of an exemplary client/server architecture used in an embodiment of the invention.

FIG. 2 is a diagrammatical partial view of the dashboard interface of one embodiment of the system.

FIG. 2A is a flow diagram of a create advertising user function of one embodiment of the system.

FIG. 2B is a flow diagram a coupon campaign creation or modification function of one embodiment of the system.

FIG. 3 is a flow diagram of a user access function of one embodiment of the system.

FIG. 4 is a diagram of an advertising user record for use in one embodiment of the system.

FIG. 5 is a diagram of an indicating user record for use in one embodiment of the system.

FIG. 6 is a flow diagram of a coupon selection function of one embodiment of the system.

FIG. 7 is a flow diagram of an add money function of one embodiment of the system.

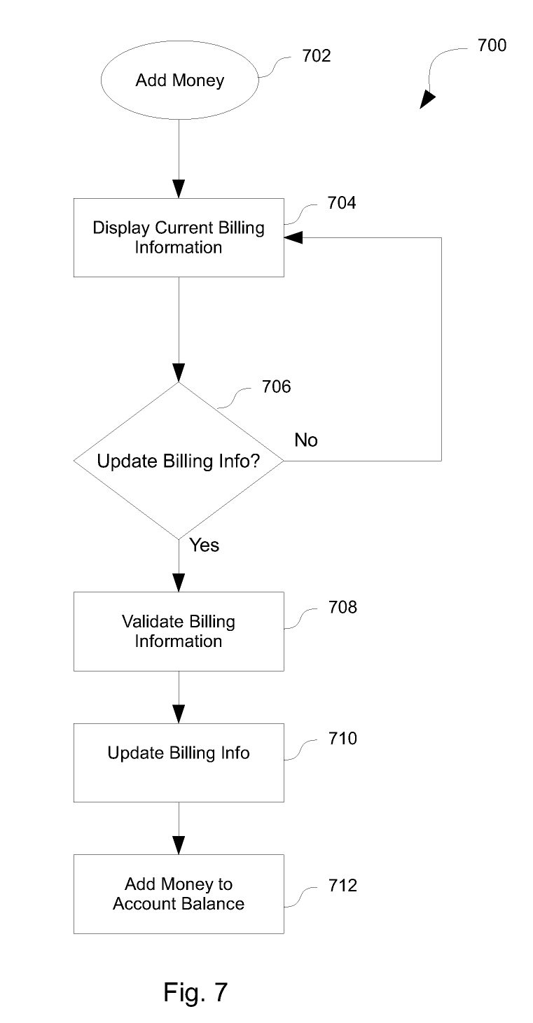

### DETAILED DESCRIPTION

Methods and systems for generating and distributing a pay-for-push coupon over a network are disclosed. The following description is presented to enable any person skilled in the art to make and use the invention. For the purposes of explanation, specific nomenclature is set forth to provide a plural understanding of the present invention. While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

### System and Method Overview

The coupon distribution system 100 comprises a system having at least two classes of users, advertising users and indicating users. The system allows advertising users to provide, through the system, coupons or discounts to indicating users and/or recipients who have expressed an interest in the advertising user's goods or services or have expressed an interest in being in a location that is at or near the advertising user's business location. The coupons may include discounts on specific goods or services, passes for free goods or services, access codes for VIP venue entry, or any other discount, incentive, or gift.

In one embodiment, the system 100 provides indicating a user with access to the coupon distribution system's advertiser database, which includes entities, such as retail businesses. The indicating user has one of a number of options for finding coupons related to a particular location including browsing entities that are providing a coupon in or around the indicating user's specified target location or browsing the available coupons and then selecting a location based on the available coupons. Once the indicating user has selected a coupon, the system will then provide the indicating user with the selected coupon. The system will subtract from an advertising user's account associated with the selected coupon a predefined unit coupon price, such as 0.50 dollars, per coupon delivered.

In one embodiment, the indicating user is an organizing user. An organizing user is an indicating user that seeks to organize a meeting of two or more people (recipients) at a target location. Once a user has selected a coupon, the system will prompt the user to select or enter a number of recipients who are to receive a meeting invitation specifying the target location and including the selected coupon. The coupon distribution system will then send a notification to each one of the recipients a notice with the meeting location and selected coupon. In one embodiment, the system will send each recipient a notice with a link to a website where the coupon can be retrieved. The system will debit the advertising user's account which is associated with the selected coupon by a predefined per-coupon-push amount multiplied by the number of initial recipients of the coupon.

### Exemplary System Architecture

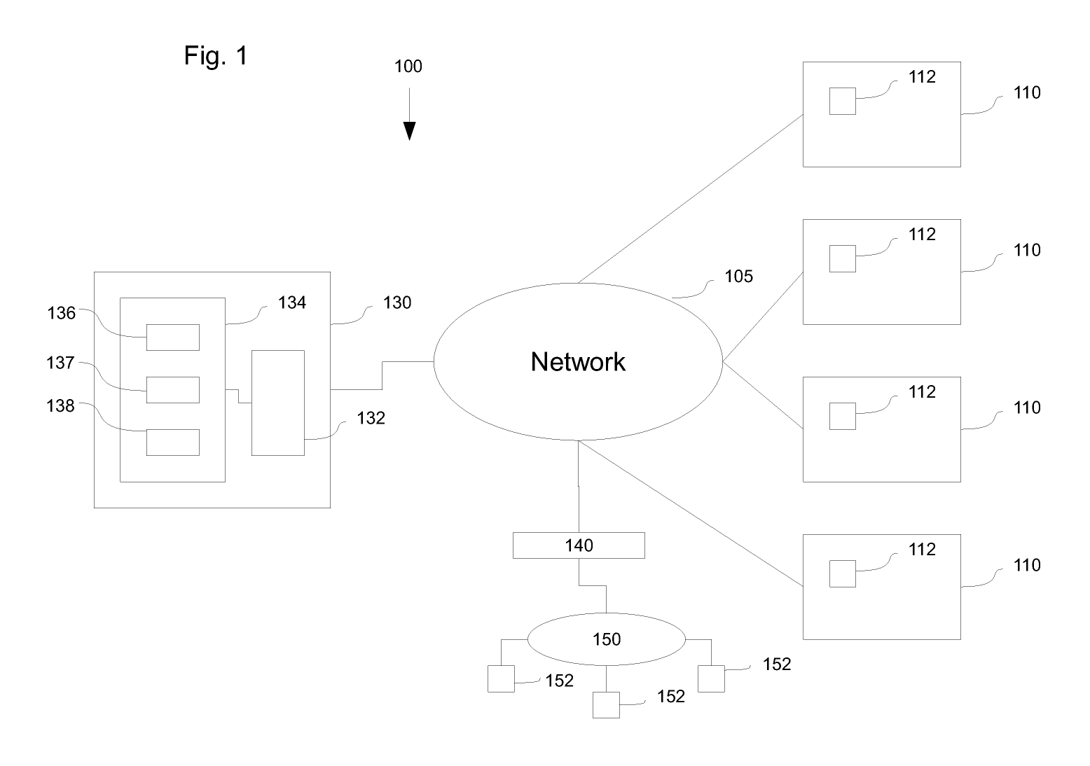

FIG. 1 is an example of a distributed system configured as a client/server architecture used in an embodiment of the invention. Clients and servers generally communicate over a computer network on different pieces of computer hardware. However, a client and server may reside on same piece of hardware or on the same system. A client may be a process, application, or system that accesses the services of a server. A server may generally be a computer that is remote from the client over a communication network, such as the Internet. A server may be a process, application, or system that responds to requests from clients. Servers generally provide information for a given computer network.

The distributed system shown of FIG. 1 includes a plurality of client computers 110, a system server 130, and an optional gateway server 140, all of which are connected to a network 105, such as the Internet. However, it will be understood that the client computers 110, the system server 130, and the gateway server 140 may connect through one of a number of different types of networks, such as local area networks (LANs), wide area networks (WANs), or other networks that might connect clients and servers.

Client computers 110 may include personal computers (PC), mobile Internet devices, personal digital assistants (PDAs), tablet PCs, smart phones, or other Internet connectable devices. Each client generally includes one or more processors signal connected to memory storage, input/output devices, and a wired or wireless network interface device. The signal connection of the processor(s) to the memory storage, the input/output devices, and the wired or wireless network interface device may occur over a system bus.

Servers, such as the system server 130, and a gateway server 140 may be configured similarly to the client computers 110. However each server may include many computers connected by a separate private network. It is also possible that the network 105 includes hundreds of thousands of individual networks of computers.

The client computers 110 are capable of executing a computer program capable of communicating with the system server 130 or web browser programs 112, such as Microsoft's Internet Explorer, Mozilla's Firefox, or Google's Chrome, capable of communicating with the system server 130. It is possible to provide certain services or information by way of a specific purpose client program or application capable of communicating over the Internet, such as applications available from Apple iTunes App Store or BlackBerry App World. Further, specific purpose client programs or applications may comprise applications operating on a general purpose computer or mobile device. At least one type of client computer 110 is capable of running such specific purpose client programs or applications.

The system server 130 comprises a computer storage medium 134 and a processing system 132. The computer storage medium 134 comprises one or more databases 136, 137, 138. In the embodiment shown, the computer storage medium 134 comprises at least an indicating user database 136 and an advertiser or advertising user database 137. The system or method of the invention may be implemented in computer software that is stored as executable instructions on a computer storage media, such as RAM memory or one or more mass storage devices, or a combination thereof on the system server 130 or connected to the system server 130. A browser program or the specific purpose client program, running on client computers 110, is used to access user account information or advertiser account information on the system server. A firewall may be provided on the system server or between the system server 130 and a client computer 110, which protects information on the server from unauthorized access. Further additional security may be provided at the point of user access by utilizing secure protocols such as Hypertext Transfer Protocol Secure (HTTPS) or other known security protocols.

In one embodiment, the gateway server 140 provides access to a secondary network 150 such as the telephone network. The gateway server enables communication between the network 105 and the secondary network 150. Devices 152, such is cellular phones, may be signal connected to the network 150. Communication to the devices 152 may be enabled via known protocols, such as the Short Message Service (SMS) protocol, or the Multimedia Messaging Service (MMS) protocol.

One type of user located at a client computer 110 may be advertising users. The advertising users may wish to access account information residing in storage 134 on the system server 130. An advertising user, through the account residing on the system server 130, may provide coupons for indicating or organizer users who demonstrate an interest in the goods or services provided by the advertising user.

A second class of users located at client computers 110 are indicating or organizer users. These indicating or organizer users may wish to buy goods or services from providers, such as advertising users, which are providing coupons or discounts. Further, these indicating or organizer users may wish to invite others, such as friends colleagues or acquaintances, to a common meeting location so that they may meet for one or more purposes, such as socializing, carrying on a common activity, or engaging in a business activity. The organizer user may wish to invite others to a meeting location where there is a coupon or a discount for goods or services provided at or near the meeting location. While generally a meeting location will be a physical place, in one embodiment, the system 100 allows for a meeting location to include a virtual meeting location where one or more participants join other participants via telephonic or electronic communications, such as teleconference, videoconference, or the like.

### Options and Functions

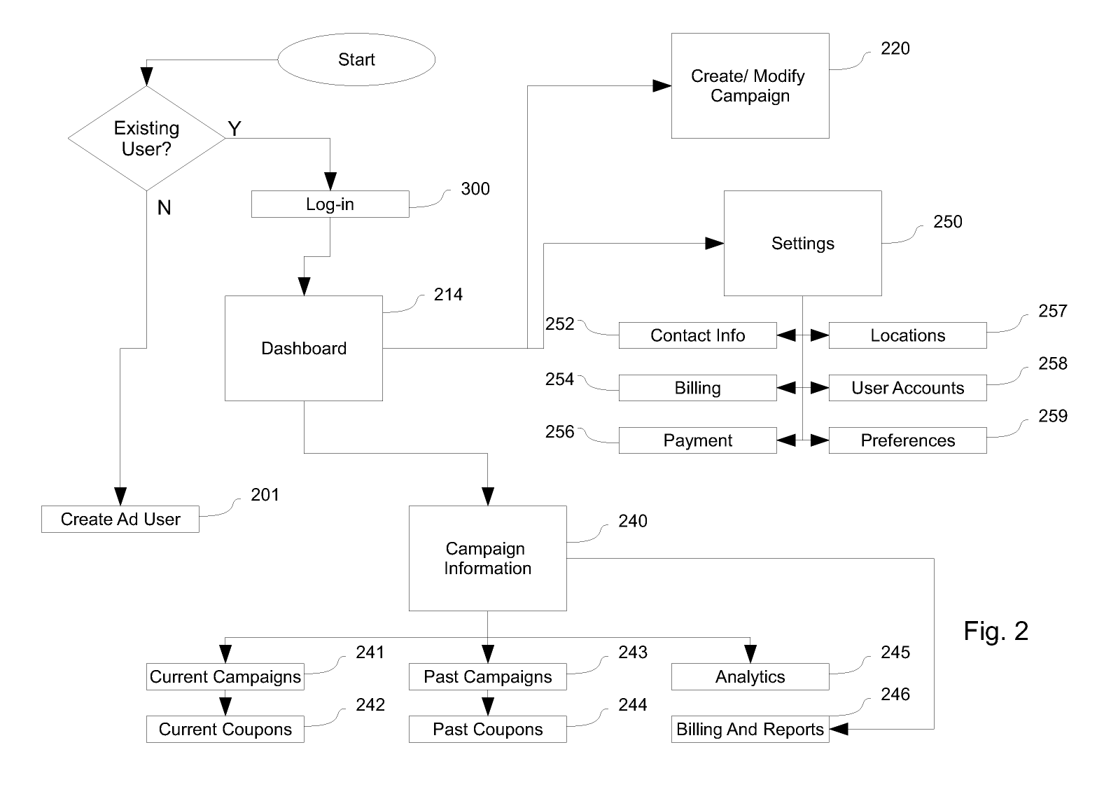

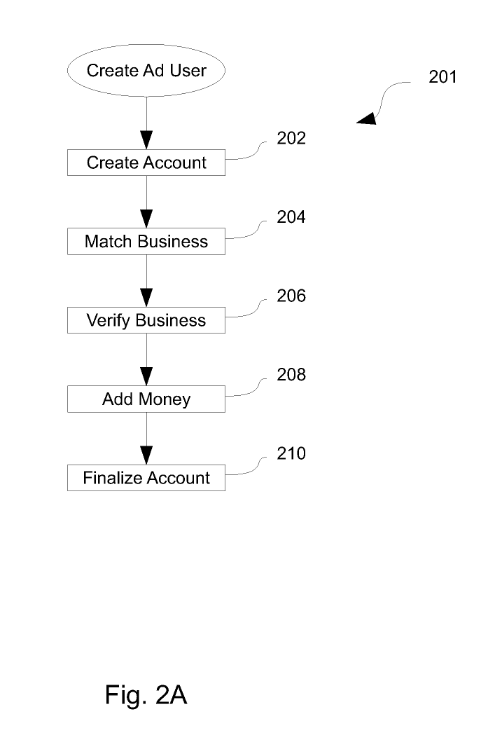

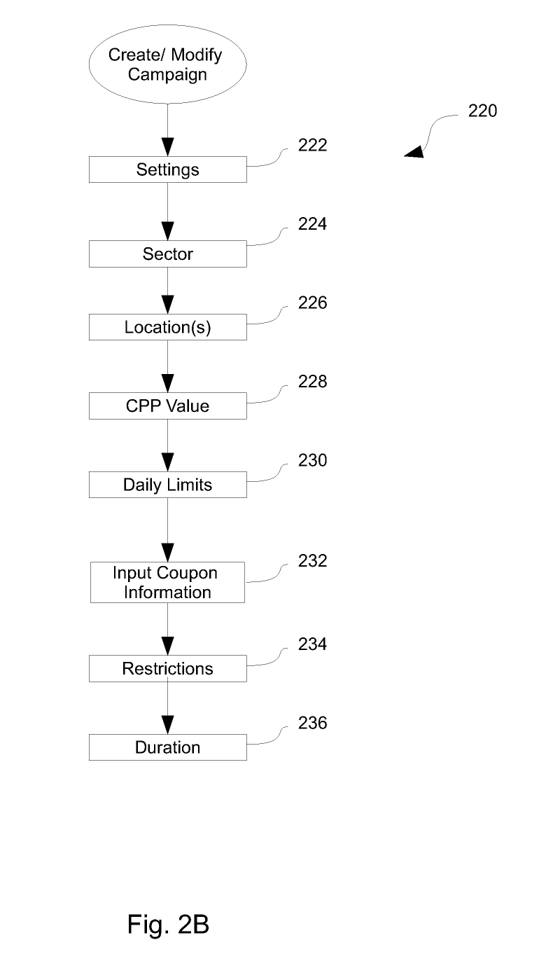

FIG. 2 is a diagram showing how an advertising user accessing the system server might navigate the available options of the system. The advertiser, upon entering the URL of the system server 130 into a browser program or through a specific purpose client application, invokes a login application, discussed below as shown at step 212, running on the processing system 132 of the system server 130. Once the advertising user is logged in, the user is provided with the dashboard 214, which includes one or more options corresponding to system functions including a create/modify a campaign function 220, a campaign information function 240, and a view and modify settings function 250. These functions, which will be discussed in more detail below, cause routines of the system to be invoked to either implement the advertising users request or request further information prior to implementing the advertising user's request.

### User Access

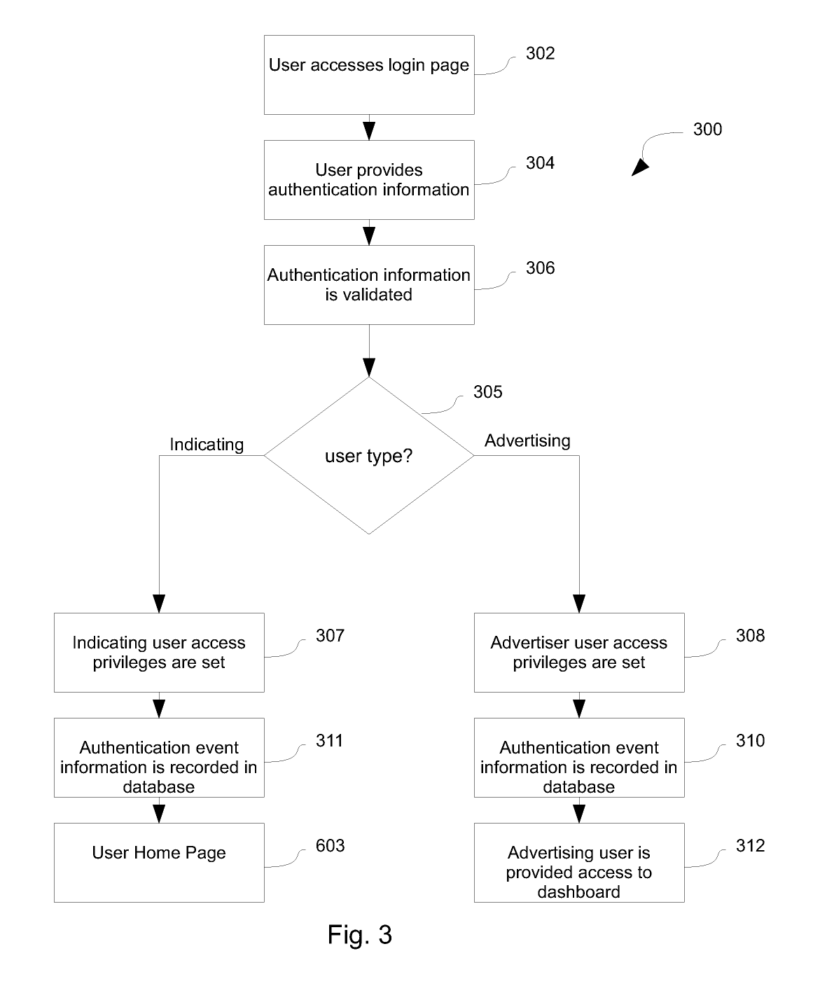

A login function 300 for users including indicating users and advertising users is shown in FIG. 3. The advertising user enters the URL of the login page into a browser program or accesses a login page through a specific purpose client application, whereby the processing system 132 of the system server 130 invokes a login function at step 302 to serve the login page. In this application, the processor provides an input screen that request user authentication information, such as a user name and password. The authentication information is provided by the user at step 304 and is validated or authenticated by the login application at step 306 by comparing the authentication information provided by the user records in the advertising user database 137 and/or the indicating user database 136 provided in the storage 134. In another embodiment, the system might provide separate login pages for advertising user and indicating users so that only one of the advertising user database 137 and or the indicating user database 136 are checked, which corresponds to the login page for that type of user.

At step 305, the system determines based on the authentication information which type of user is attempting to access the system. At step 305, the system determines the appropriate processing path based on the user authentication information. However, at step 305 the system may also determine access for other types of users such as administrator users.

If, at step 305, the system matches the authentication information to an indicating user record 500 in an indicating user database, then at step 307 the system will set the user access privileges so as to limit the read write access privileges that correspond to the indicating user account. In one embodiment, the indicating user database and advertising user database may be one unified user database located on the storage 134. In another embodiment, the indicating user database and advertising user database may comprise one or more separate user databases on the storage 134.

If, at step 305, the authentication information is validated by a match to an advertiser record or advertising user record 400 in the advertising user database, then the system sets the user access privileges so as to limit the read write access privileges that correspond to an advertising user account at step 308. At steps 310 and 311, the system records the authentication or login event into the corresponding indicating user database or advertising user database or another database on the storage 134 so as to keep a record of user access to the system. Such authenticating event information may provide an audit trail whereby an account owner or a system administrator may be able to view that information. After the user has been authenticated, in the case of an advertising user, the system provides the advertising user access to the dashboard 214 at step 312. In the case of an indicating user, the system provides the indicating user with access to an indicating user home page 603.

Access to user account information located in a user database is limited to users having an account record on the system. Such an account record has authentication information from which a user logging in can be compared against. If an advertising user account does not exist, one can be created by the process shown at step 202 in FIG. 2.

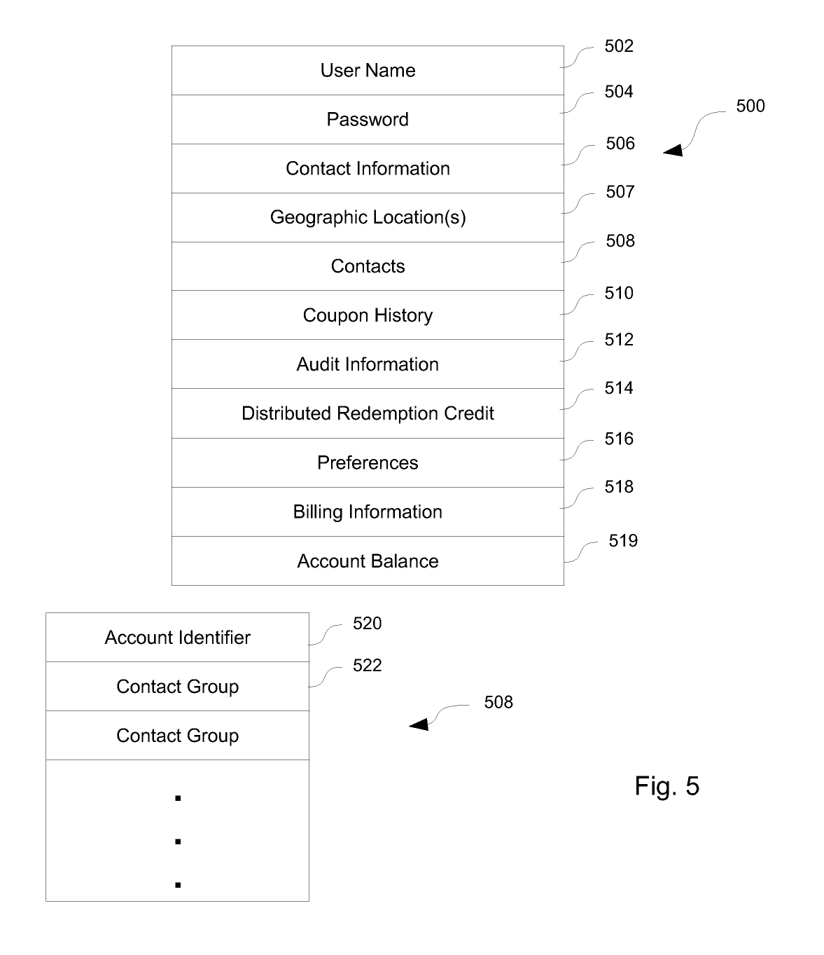

If an indicating user account does not exist one can be created by a process that prompts and receives information from the user to complete one or more of the sections in an indicating user record 500. An exemplary indicating user record 500 is shown in FIG. 5. The indicating user record 500 includes authentication information, such as a user name and password, in the user name and password sections 502 and 504. User's contact information such as a street address, phone number(s), and e-mail addresses is contained in contact information section 506. The user record 500 may contain in geographic locations in the geographic information section 507 corresponding to geographic locations of entities which a particular user had saved or of which the user frequently visits. The user record 500 may also contain a coupon history section 510 having a history of the past coupons that the user has selected. User record 500 also may contain audit information in the audit information section 512 that contains information similar to that contained an audit information section 412 of an advertising user record 400. In one embodiment, the user record has billing information in a billing information section 518 and account balance information in an account balance information section 519.

### New Advertising User

In FIG. 2, if the user does not have an account, the system calls a create new advertising user program 201 at step 202, where the system prompts the user for user information and records that information in a user record 400.

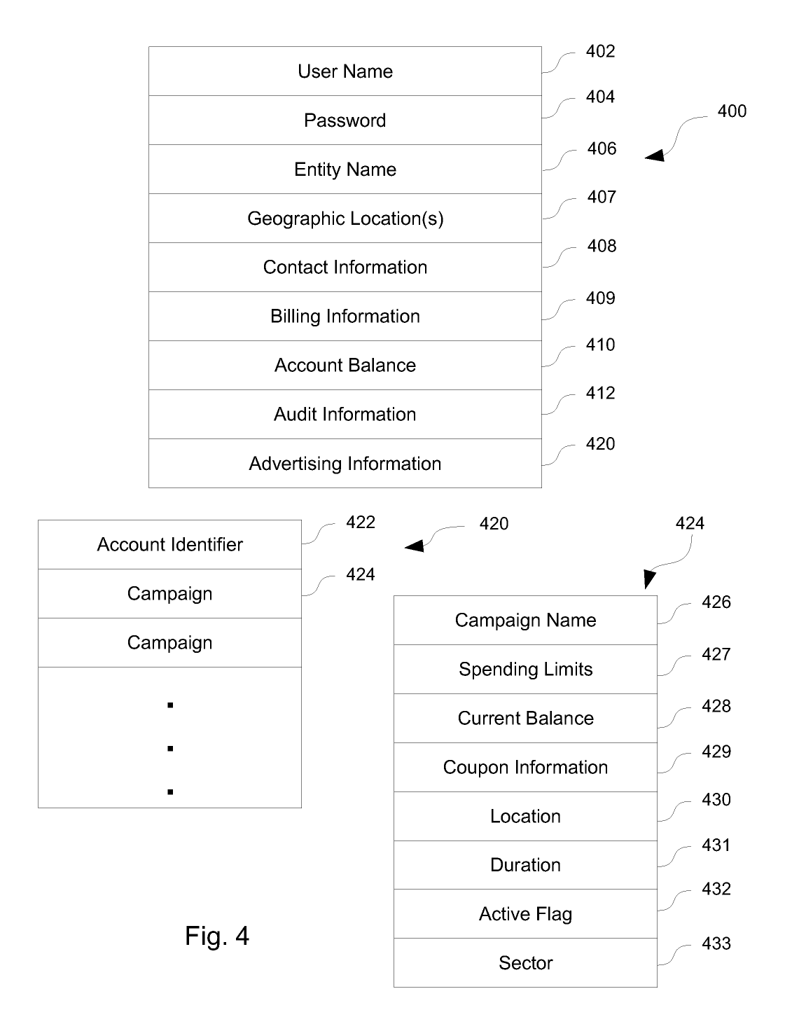

An exemplary advertising user account record 400 that would be contained in the advertising user database 137 is shown in FIG. 4. The record 400 has a username section 402, a password section 404, an entity name section 406, a geographic locations section 407, a contact information section 408, a billing information section 409, an account balance information section 410, an audit information section 412, and an advertising information section 420.

At step 202 the system prompts the user for a username and password. The system checks that the user name is unique as compared to all of the other user names in the system. The system also checks that the password meets the minimum password requirements, such as it being a sufficient length and/or containing certain types of characters such as special characters. If the user name is unique and the password meets the minimum requirements, then the system saves the user name and passwords to the respective user name and password sections 402, 404 of the user record.

In one embodiment, the system server 130 has an entity/business directory database 138 located on the storage 134. The business directory database has records pertaining to businesses within a geographic area. A record in the business directory database may contain the following information: a business name, geographic location(s) of the business establishment, a phone number, a contact person, a website address, an e-mail address, and other contact information. The business directory database may be pre-populated from publicly available sources of information, such as the Internet, business directories, and the like. In one embodiment, the business directory database and the advertising user database comprises one database, wherein a record includes business information such as just described as well as user authenticating information as shown in FIG. 4. If the owner of a business listed in the database has not claimed its business listing, then user authentication information may be blank or not active in that record. In another embodiment, the business directory database 138 and the advertising user database 137 are separate databases.

In step 204, the system prompts the user to identify the business or entity for which the account is to be created. The system will record the entity name in the entity name section of the user record after an ownership or authorization verification procedure. The entity name section 406 includes information such as a business or organization that seeks to provide a coupon or discount through the system. In one embodiment, it will be understood the advertiser database and advertising users records therein may include any entity, operation, organization, or individual seeking to provide information, goods, services, or charitable functions. The entity identification process may include the system prompting the user to enter the information about the business or entity directly and or by the system providing the user with a list of businesses or entities and the option for the user to select one of the pre-existing businesses or entities already contain within the business directory database.

At step 206, the create new user program calls an ownership or authorization verification procedure. This ownership verification procedure insures that the user attempting to register an advertising user account is the owner of the business or entity or is someone authorized by that business or entity to create an account in the system. This ownership verification procedure prevents third parties not associated with the business or entity from fraudulently claiming ownership or authorization regarding that entity's listing. The ownership verification procedure may involve the system calling a publicly available phone number associated with the business or entity, whereby the user will answer the call and receive a verification code which then the user will enter at step 206 to confirm ownership or authorization. Alternatively, the ownership verification procedure may cause postal mail to be issued to an address publicly associated with the business or entity, whereby that mail will include a verification code which the user, when it receives the mail, will enter into the system at step 206 to confirm the ownership or authorization related to that entity's listing. Other ownership verification procedures known in the art may also be used.

Once the ownership verification procedure verifies ownership of the business and the related locations of the business, the system records the business or entity name in the entity name section 406 of the user record 400, the related verified geographic locations of the business or entity in the geographic location section 407, the business's contact information in the contact information section 408. The contact information section 408 may comprise a number of fields containing contacting information such as phone numbers, fax numbers, website addresses, e-mail addresses, and other electronic contact information.

At step 208, the add funds function 700 is started at step 702 as explained below. After funds have been added to the account, the system provides any verification or confirmation of the user account details. The user is then directed to the dashboard 214.

Audit information is stored in the audit information section 412, which contains a list of all the events where the advertising user record 400 is accessed. Each time an advertising user record 400 is accessed or modified, by an administrator or by an advertising user, the system creates an entry describing account access and/or modification event and the user causing the event, which is recorded in the audit information section 412.

### Dashboard Overview

Referring to FIG. 2, once the advertising user is logged-in via the login function 300, the processing system 132 provides a dashboard menu 214 that has a plurality of options and services for the advertising user. These items, which will be discussed in more detail below, cause routines or functions to be invoked to either implement the advertising user's request or that request further information prior to implementing the advertising user's request. In one embodiment, the advertising user may access several options through the dashboard 214, including the create/modify campaign function 220, campaign information function 240, view and modify settings function 250. The functions available via the dashboard 214 may be presented by the system as a series of steps or screens or may be provided for input from a single screen.

### Create or Modify a Coupon Campaign

Referring to FIG. 2B, in the create or modify campaign function 220, the system allows an advertising user to create or modify a campaign. The system provides the user with the option of creating a new campaign or modifying an existing campaign, if any exist. If the user indicates the desired to create a campaign, then the system prompts a user for input and/or receives inputs from the user which the system then places into the proper fields or sections of a campaign record 424, which is associated with an advertising user account record 400.

The advertising information section 420 of the user record 400 contains information that the system utilizes to make coupons or discounts available to indicating or organizing users. The advertising information of each advertising user record may be organized into one or more coupon campaign records 424. The campaigns are organized under an account identifier 422 related to the advertising user. In one embodiment, each campaign record 424 has a campaign name section 426, a spending limit section 427, a current balance section 428, a coupon information section 429, a location section 430, a temporal duration section 431, an active flag section 432, and a sector section 433.

At step 222, the system prompts the user for information regarding the campaign name, which the system records in the campaign name section 426. At step 222, the system prompts the user for the market sector that the corresponding business or entity operates in, such as food service, retail, auto repair, blood donation, etc. The system may provide a multi-level definition of market sectors, such as where the “coffee shop” sector is a subsector of the “food service” sector. Therefore the user may specify a plurality of sectors relevant to a particular campaign. The system records the sector information in the sector section 433 of the campaign record 424. In one embodiment, the user record 400 may have a sector section that contains user defined sector information. The system may provide the user with the option of selecting the preexisting sector information from the user record and applying it to a particular campaign record 424.

At step 226, the system prompts the user for geographic locations where this coupon is valid and where the advertising user seeks to have the indicating users or recipients redeem the coupon. The geographic locations could be, in the case of a retail establishment, the physical stores or locations where the retail establishment exists. The system stores the geographic location information in the location section 430 of the campaign record 424. The system may provide the user with a list of locations specified in the geographic location section 407 of the user record 400. The system may limit the locations available to a user for a campaign to those geographic locations recorded in the geographic location section 407 of the user record and which have been previously verified as owned by the user or for which the user has authorization to act on behalf of the owner.

At step 228, the system displays to the user the cost-per-push that will be deducted from the user's account balance for each recipient to which the coupon is sent. In one embodiment, the system may also display a cost-per-redemption that will be deducted from the user's account balance each time a coupon is redeemed.

At step 230, the system prompts the user to specify the spending limits associated with a campaign of the campaign record 424, which are recorded by the system in the spending limit section 427. The spending limit specifies the maximum amount of money that the advertising user will allow its account to be debited under the campaign corresponding to the campaign record. In one embodiment, an advertising user's account is debited each time the coupon is sent from the system to a recipient. By limiting the total amount that can be spent under the campaign, the advertising user can limit the number of coupons that are distributed. Further the advertising user can limit the amount of advertising expense that is incurred under a coupon campaign. The spending limit section 427 may comprise a campaign spending limit and/or an hourly, daily, weekly, and/or yearly spending limit. Therefore, the advertising user can control not only how much money is spent on the campaign overall, but also how much is spent on a given hour, a given day, a given week, and/or a given year.

At step 232, the system provides the user with options for inputting coupon information, which the system stores in the coupon information section 429. The coupon information section 429 of each coupon campaign contains information that an indicating user or a recipient can use to redeem the coupon. Such coupon information could include a code, a UPC label, text, or graphic information. It may also have any additional information that the advertising user desires to provide to an indicating user or recipient, such as upcoming event information. In one embodiment, the system provides an interface for the advertising user to design a coupon and input coupon information. The system may also provide an upload function where the system provides the user with the ability to provide part or all of the coupon information in one or more pre-defined data formats, such as a JPG or PDF format.

At step 234, the system prompts the user to optionally define one or more restrictions regarding the coupon campaign, which the system will record in one or more sections of the campaign record 424. Restrictions may include rules, exclusions, exemptions, or other restrictions typically provided in a coupon offer.

At step 236, the system prompts the user to define the expiration date or temporal duration or time period during which the coupon is valid within the system, which the system will record in the temporal duration section 431. This temporal duration section 431 is where the user defines when and how long the coupon will be available via the system to end users. However, this temporal duration is different from any redemption expiration dates. A redemption expiration date is a date before which a user must use or redeem the coupon. Therefore, the data recorded in the duration section 431 may be different from the redemption expiration date for a particular coupon. The system may optionally provide a summary information page detailing some or all of the user defined parameters of the coupon campaign and request the user confirm the accuracy of those parameters. When the create a campaign function 220 is finished, the system will return the user to the dashboard 214. One skilled in the art will recognize that the steps of the create a campaign function 220 may be carried out in any order and in some embodiments not every section of the campaign record 424 will require data to begin a campaign.

Each campaign record 424 contains an active flag section 432 which records a value indicating whether or the campaign is currently active or inactive. A campaign may be activated or deactivated manually by a user. Alternatively, a campaign may be deactivated because the spending limit has been reached or when the duration expiration date or value in duration section 431 has expired or passed. In one embodiment, the system provides a check for expired campaigns function, which the system runs regularly, such as daily, or manually, where the system compares the expiration information in the duration section of each campaign 424 and sets the active flag section 432 to inactive for each campaign that has expired or is outside of its predefined temporal duration. The system may, whenever providing information to an indicating user regarding coupon campaigns, only provide information regarding active campaigns. The system may also provide the indicating users with the option to view expired campaigns, but in such cases the system will not provide coupon information sufficient to achieve coupon redemption at the advertiser's location.

The modify subfunction of the create or modify campaign function 220 provides an interface where the user is allowed to change one or more attributes about the campaign in the corresponding campaign record, such as attributes contained in the campaign record 424. After receiving modification information for the user, the system makes the corresponding modifications to the data in the campaign record 424.

In another embodiment, the system comprises a coupon database on the storage 134 separate from the user database; the coupon campaign information is maintained in a structure similar to campaign record 424 with an additional account identifier field for correlating the campaign with an advertising user record 400 in the advertising user database.

### Additional Options

The campaign information function 240 of the system provides, to an advertising user, data about the current coupon campaigns 241 and the corresponding current coupons 242 that are active, past coupon campaigns 243 and corresponding past coupons 244 that are currently not active, statistical activity reports about the performance of current and past campaigns 245, and billing report information 246.

The system has an view and modify settings function 250, which allows an advertising user to retrieve or modify information with various subfunctions, such as update user's contact information function 252, a billing information function 254, a payment information function 256, a locations function 257, a user accounts function 258, and a preferences function 259, where at least part of the data for one or more of those functions is saved in the user record 400 by the system.

In the locations function 257, the system allows the user to define or modify the geographic locations associated with the advertising user, which are saved by the system in to the geographic locations section 407 of the user record. Generally, these geographic locations are those locations where the entity will provide goods or services, such as a retail establishment. As it is known that businesses may often have more than one location of operation, the geographic locations section 407 may comprise multiple fields. Each time a user attempts to add a new location to the user record, the system may call the ownership or authorization verification procedure as discussed in step 206 of the a create new advertising user function to verify that the user attempting to register an advertising user account is the owner of the business or entity at the new location or it is someone authorized by that business or entity at the new location to register that location as associated with the advertising user.

In the contact information function 252, the system prompts the user to modify or add contact information, which the system saves in the contact information section 408 of the user record 400.

In the billing information function 254, the system prompts the user to modify or add billing information, which the system saves in the billing information section 409 of the user record 400. The billing information section 409 may comprise a number of different fields all containing information related to billing, such as, credit card information, bank account information, electronic funds transfer information, and past transaction history information. The billing information section 409 contains data accessed when the advertising user selects the option to make a payment and add money in advertising users account. One of the billing information section 409 components includes the account balance section 410 which contains the funds available to the advertising user in the system.

In the payment information function 265, the system provides the user with a history of prior transactions where the user has added funds through the add funds function 700. It may also provide an option for the user to add funds. If the user accepts this option, the system calls the add funds function 700, which is explained below.

In the advertising user accounts function 258, the system allows a user to create multiple login accounts for the related single business or entity. Each advertising user login account will be associated with advertising user record 400. Advertising user login account may have varying levels of access permissions. Therefore a business owner may designate an account for the owner himself or herself and an account for the operating manager of the business, whereby the operating manager can perform certain tasks as limited by the owner's predefined permissions for that user. For example, the manager's account may allow the manager to create new coupon campaigns but not add funds.

In the preferences function 259, the system prompts the user to modify preferences related to various aspects of the system, such as interface display preferences, which the system records in the user record 400.

### Add Funds

When the add funds function 700 is invoked the system receives data identifying the corresponding advertising user and retrieves the advertising user's account from the database. The executing process then stores the advertising user's default billing information, if any, and displays the default billing information for the advertising user in step 704. The displayed billing information includes a default amount of money to be added, a default payment type, and default payment instrument information. In the case that no billing information exists in the user record, step 704 is skipped and the system requests payment information and a payment amount from the user.

The advertising user may add funds online and substantially in real time through the use of a credit card, debit card, or electronic funds transfer. For example, advertising users may add funds to their account by transferring the desired amount from the advertising user's bank account through an electronic funds verification mechanism known in the art. The system receives from the user payment instrument information having further details regarding the type of payment. For example, for a credit card, the instrument information may include data on the name of the credit card (e.g., MasterCard or Visa), the credit card number, the expiration date of the credit card, and billing information for the credit card (e.g., billing address).

At step 704, the default billing information is displayed to the advertising user in a web-based form. The system provides interactive components so that a user may select to modify various components of the default billing information. After the user provides the appropriate billing information or modifications thereto, the user submits changes to the information at step 706. The system proceeds to step 708 and calls a validate billing information function to validate the billing information changes or entries provided by the user. The validated information is displayed back to the advertising user for confirmation at step 708.

Under the validate billing information function, if payment is to be debited from an advertising user's external account, payment may be authenticated, authorized and completed using the system set forth in U.S. Pat. No. 5,724,424 to Gifford. However, if the payment type is by credit card, a validating algorithm is invoked by the system, which validates the credit card number using a method such as that set forth in U.S. Pat. No. 5,826,241 to Stein. The validating algorithm also validates the expiration date by a comparison with the current system date and time.

After the validate billing information function has validated the user provided billing information, the user is provided with an entry form, such as a confirm button, to provide the user's final authorization for the transaction. In step 710, the billing information provided by the user may be saved as default billing information by the system in the advertising user database or another database on the storage 134. In step 712, an add funds to account balance function is called and executed by the system to add the money defined by the user in the prior steps to the advertising user's account balance 410. That add funds function also updates the advertising user's billing information and appends the billing information to the advertising user's payment history in the billing information section 409 of the corresponding user record 400.

If the payment type is by a form of electronic funds transfer or credit card payment advertising users account is credited immediately at step 712. Further, the system may provide a screen showing the status of the ad funds transaction and appropriate receipt information with the new current balance reflecting the amount added by the completed transaction.

In one embodiment, the system has a indicating user add funds function that operates identical to the add funds function 700 except that indicating user add funds function operate to modify the contents of the indicating user record 500 sections, such as the billing information section 518 and account balance section 519 to represent funds contained in or added to an indicating user's account.

### Coupon Selection and Redemption

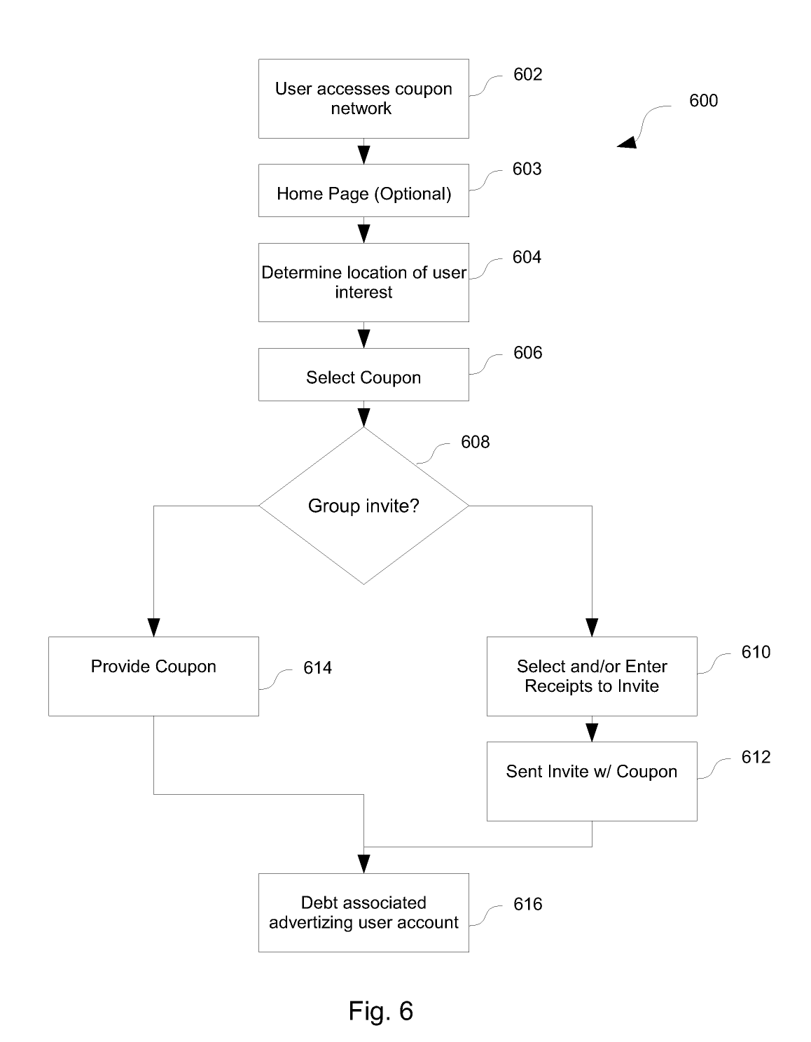

FIG. 6 shows an exemplary embodiment of the coupon selection function 600 of the system. At step 602, the indicating or organizing user accesses the system. In one embodiment, the system at step 602 calls the user authentication process shown in FIG. 3 beginning at step 302 and returns to the coupon selection function 600 at step 603 after the authentication process is complete. In another embodiment, the indicating user accesses the system without prior authentication and the home page provided by the system at step 603 is a default home page.

At step 604, the system implements a location determination function to determine the geographic location where the indicating user seeks to find a coupon discount. This location determination function may be implemented in a variety of ways. In one embodiment, the location determination function may request that the user input the geographic location of interest. This may be done by receiving any of the following information from the user: street address information, neighborhood information, city information, zip code information, latitude and longitude information, global positioning system (GPS) information, cellular tower triangulation information. In another embodiment, where the user is accessing the system with the client computer 110 that has a GPS capability or other location determining capability, the system may call a get current location function of that client computer 110. The system will then receive the value returned by the get current location function of the client computer 110.

In one embodiment, the system may utilize a specific purpose client application that is developed for a specific platform, such as a social networking platform. Social networking platforms may include Facebook, Yelp, Gowalla, Foursquare, CityGrid, or other platforms. The system application may call or utilize an application programming interface (API) of a platform to access and make use of the services and resources provided by the platform software program that implements that API. Several platforms, such as the above social networking platforms, provide a location declaring functionality so that their users can specify the user's geographic location to the platform and/or announce the user's geographic location via the platform to other platform users. Further, such location declaring functionality may be configured to access the GPS data of the user's mobile device so as to automatically, or as permitted by the user, obtain the user's geographic location and relay that information to the platform. Therefore, the system may use an API to retrieve location information of a user from third party software, such as a platform. Also, the system may use an API to send information. For example, the system may use an API to send invitation or coupon information in either of steps 614 or 612. As a further example, the system may also retrieve contact or recipient information through an API in step 610. Moreover, the system may utilize an API to carry out several or all of the information sending and receiving functions of the system.

In one embodiment, the system records prior location interest information, which was expressed by the indicating user previously and recorded in the preferences section 516 or the coupon history section 510 of the user record. The system may provide the user with a selection list of previous location interests of the user as pulled from the user record 500. The system will then use the selected location during the current session. In another embodiment, the system may use the immediate last location interest of the user, as previously recorded in the user record by the system, in the current session unless otherwise directed by the user. In a further embodiment, the system may recognize a previous user by reading an indicator, such as a cookie, from the user's client computer 110. The cookie contains information about the user's preferences and prior use, which the system may use in place of information from a user record 500.

At step 606, the system takes the indicating user's location information retrieved in step 604, and uses that information to query the advertising user database for qualifying advertisers and qualifying coupon campaigns having a coupon campaign record 424 that provides a location in the location section 430 within a predefined distance from the indicating user's location of interest. The predefined distance between the indicating user's location of interest and the location of a coupon campaign maybe defined by the user at step 604 or 606 or maybe predefined by the user or the system and saved in the indicating user record 500. The predefined distance may include geographic distances such as miles or feet or location information such as blocks, neighborhoods, or cities. The qualifying advertisers and/or qualifying coupon campaigns will be provided or displayed to the user along with information elements of the coupon campaign record 424. The system then provides the user with the option to browse the qualifying coupon campaigns and/or qualifying advertisers and the option to select a coupon therefrom. Before steps 614 and 612, the system provides coupon information sufficient for the user to understand at least some of the benefits, terms, and conditions of the coupon but does not provide information sufficient to redeem the coupon. At step 614 the system and provides the indicating user with the selected coupon, which includes information sufficient for a user to redeem the coupon.

At step 608, the system that will determine whether the indicating user is an organizing user desiring to organize a meeting of two or more people (designated recipients) at a target location. The system will determine whether an indicating user is an organizing user, by prompting the user for such information or by retrieving preference information from the user record. If the user is an organizing user, once a user has selected a coupon, the system will prompt the user to select and/or enter a number of designated recipients at step 610 who are to receive a meeting invitation specifying the target location and including the selected coupon. Designated recipients may be pulled from the contact information section 508 of the user record 500, and may comprise any number of contact groups 522 or individual contacts. The contact groups are organized under an account identifier 520 related to the user record 500. Also the designated recipients may be entered manually at step 610. Further the system may provide a get contact function that pulls contacts from a user e-mail or other third-party source of the user's contacts. Generally a contact and a recipient will each be defined by a least one addressing component, such as an electronic address, such as an email address, or phone number. A contact and a recipient may each also include other contact information. At step 612, the system will send a notification to each one of the designated recipients with the meeting invitation, having meeting detail information, and the redeemable coupon that was selected by the organizing user. The system will send a notification to the recipient via one or more of the addressing components associated with that recipient. In one embodiment, a meeting is not required; instead the organizing user may seek to distribute the coupon to designated recipients without intent to meet.

The system may configure the coupon provided in step 612 and 614 so that it is capable of being displayed on a mobile device and redeemed at the redemption location directly from that mobile device. One method of redeeming a coupon directly from a mobile device is by scanning a barcode of the coupon displayed on the mobile device.

After each of steps 614 and step 612 the system moves to step 616 where the system implements a per-push debit function comprising subtraction from the advertising user's account that is associated with the selected coupon by a predefined unit coupon push price. If the coupon was sent to a number of designated recipients by an organizing user, the system will debit the advertising user's account which is associated with the selected coupon by a predefined unit coupon price multiplied by the number of designated recipients specified by the organizing user. The system may designate the organizing user as a designated recipient or the organizing user may choose whether or not to designate himself or herself as a designated recipient. Therefore the advertising user will be charged a predefined unit coupon amount for each person that initially receives the coupon via the system.

In one embodiment, each coupon that is distributed to a designated recipient may contain a unique coupon identifier which is unique from the unique coupon identifier contained on any other designated recipient's coupon. The unique coupon identifier may contain alpha-numeric characters, numbers alone, a bar code, or other words or symbols. The unique coupon identifier can be used by the system to track which of the recipients redeem the coupon. Further it can be used by the system to determine whether a designated recipient distributed his or her coupon to others. In one embodiment, the system may provide incentives for designated recipients to further distribute the coupon to others.

In one embodiment, the coupon may contain a per-push coupon identifier. The per-push coupon identifier will be the same for all coupons that are sent by the system during a single coupon-push event by an organizing user. The system may use this per-push coupon identifier to track the redemption of coupons on a per-push event basis.

Further, the coupon may contain an organizing user identifier. The organizing user identifier and/or the per-push coupon identifier may be a subset or contained within another identifier such as the unique coupon identifier. The organizing user identifier may be unique to each organizing or identifying user of the system. The system may use this identifying user identifier to track the how many coupons—distributed by a particular organizing user—were redeemed.

In one embodiment, the system subtracts a predefined coupon redemption amount from the advertising user's account—that is associated with the coupon—each time that coupon is redeemed at or through the advertising user designated redemption location(s) or method. In this step, the system subtracts a unit coupon redemption amount from the associated advertising user's account when the system receives a redemption event notification. The redemption event notification may contain a unique coupon identifier that contained in the distributed coupon. The subtraction of the predefined coupon redemption amount from the advertising user's account may occur in addition to or instead of step 616

The system may comprise a redemption event receiving function. The receiving function provides a means for receiving redemption event information. The system may provide an entry screen on an application specific client program or webpage at a URL where an advertising user can enter coupon redemption information. The system may provide a portal for receiving the information in bulk, such as in a file. The system may provide an redemption API whereby the system can be directly linked to a third party system of the advertiser, such as a Point-of-Sale system (POS), to receive redemption information in real-time, or within a predefined amount of time after redemption, or in batch groupings at predefined or user defined times. Alternatively, the system may comprise a redemption capture application or function that captures the unique coupon identifier, such as a barcode, and transfers the redemption event information to the system. The system may provide redemption information to the associated advertising user on the user's dashboard 214. The redemption capture function may be embodied in a mobile electronic or computer device and employed at the advertiser's point of sale or the advertiser's point of coupon redemption, which may be the point of sale.

In a further alternative embodiment, the system doesn't require an indicating user to authenticate at step 602, but instead the system prompts the user to proceed through the authentication sequence after the coupon is selected at step 606.

In a further alternative embodiment, the system never requires an indicating user to authenticate. Under this non-authenticating embodiment, the system requires the user to input necessary data at the appropriate steps, which would otherwise have been contained in an indicating user record 500 and retrieved therefrom by the system.

In another embodiment, step 604 maybe skipped, and instead the user may be provided with a number of options for searching for coupons. For example, the system may provide the user with input options so that the user may be able to search for coupons from a particular user specified entity or business. Then the system would then carry out the appropriate query against the advertising user database based on the user's specifications. Further, the user may be provided with options for the user to search the available coupons based on the particular type of product or service, a class or category of goods or services, type of business, or the like.

The system may have a credit indicating user function in which the organizing user receives a predefined distributed redemption credit amount each time a coupon that the organizing user distributed is redeemed. The indicating user record 500 has a distributed redemption credit section 514 which contains the amount of credit received as distributed redemption credit. Under one process, at or after redemption event information is received by a redemption event receiving function, the system processes the redemption event information and associates the redeemed coupon with the indentifying user that distributed the coupon by reading the coupon identifier information, which is a component of the redemption event information. For each redeemed coupon a predefined credit is added to the distributed redemption credit section 514 of the associated indentifying user's account 500.

The credit provided in section 514 may be divided in to subcredits corresponding to the advertiser to whom the redeemed coupon was associated. There the credit granted by the system for each redemption is associated with the corresponding advertiser whose coupon the credit was generated from. In one embodiment, the system only provides distribution redemption credit when a recipient, which was previously designated by the indicating user, redeems a coupon that the organizing user distributed to that recipient.

In one embodiment, the system provides the advertising user with the option of defining premium redemption coupons that are made available to indentifying user that have a predefined amount of distributed redemption credit or subcredit.

In one embodiment, the process shown in FIG. 6 is modified to provide an indicating user coupon distribution debit function a step (not shown) before both step 614 and step 610. The indicating user coupon distribution debit function debits or subtracts a predefined indicating user coupon distribution amount from the account balance provided in the account balance section 519 of the indicating user record 500 before the coupon is distributed to the user. If the account balance of the user is below the indicating user coupon distribution amount to be debited, the system will prompt the user for the option of adding funds to the user's account using the indicating user add funds function. In this embodiment, the system will not provide the coupon having information sufficient to redeem the coupon to the user at step 614 or step 612 unless the user's account has sufficient funds to cover the indicating user coupon distribution amount.

In one embodiment, the indicating user coupon distribution debit function debits an organizing user's account by a total indicating user coupon distribution amount which is equal to the predefined indicating user coupon distribution amount multiplied by the number of recipients designated by the organizing user in step 610, which may include the organizing user.

In one embodiment, when the system calls an indicating user coupon distribution debit function a step (not shown) before both step 614 and step 610, the system does not call the per-push debit function at step 616 and the advertiser's account associated with the coupon distributed is not debited.

In one embodiment, when the system calls an indicating user coupon distribution debit function a step (not shown) before both step 614 and step 610, the system calls the per-push debit function at step 616 and the advertiser's account associated with the coupon distributed is debited.

From the foregoing, it will be observed that numerous variations and modifications may be effected without departing from the spirit and scope of the invention. It is to be understood that no limitation with respect to the specific apparatus illustrated herein is intended or should be inferred.

The invention claimed is:

1. A method of distributing a coupon in response to a request from a user using a computer network, comprising:
maintaining a database including one or more coupon records associated with one or more advertisers, wherein each coupon record is associated with an advertiser credit account;
receiving a coupon request from a user for a coupon associated with a coupon record in the database via the computer network;
providing to the user the coupon corresponding to the coupon request via, at least in part, the computer network;
subtracting a coupon distribution amount from the advertiser credit account associated with the coupon provided.

2. The method of claim 1, wherein the coupon record is associated with a location value and wherein the step of receiving comprises the steps of:
receiving user location information from the user;
querying the database to retrieve a coupon result set of coupon records associated with a location value representing a geographic location within a predefined distance from the geographic location represented by the user location information;
providing the coupon result set to the user; and
receiving a selection, from the user, of one or more coupons of the coupon result set.

3. The method of claim 2, wherein the step of receiving user location information comprises the step of: receiving a user defined distance as the predefined distance.

4. The method of claim 2, wherein the user location information is selected from a group consisting of: GPS information, street address information, and business location information.

5. The method of claim 2, wherein the step of receiving user location information comprises requesting location information from a location-aware device of the user.

6. The method of claim 1, wherein the step of providing comprises the step of providing one or more recipients designated by the user with a coupon corresponding to the coupon request.

7. The method of claim 6, comprising the step of, before the step of providing, receiving a recipient group comprising one or more recipients designated by the user to receive the coupon corresponding to the coupon request.

8. The method of claim 6, wherein the step of subtracting comprises the step of:
total cost calculating a total coupon-push-cost by multiplying the number of recipients by a unit coupon price, wherein the coupon distribution amount is the total coupon-push-cost.

9. The method of claim 6, wherein the step of subtracting is further defined in that the user is a recipient.

10. The method of claim 6, comprising the steps of,
before providing, total cost calculating a total coupon-push-cost by multiplying of the number of recipients times a unit coupon price, wherein the coupon amount is the total coupon-push-cost;
before providing, checking a advertiser credit account balance of the advertiser credit account associated with the coupon to be provided; and
wherein the step of providing occurs if the total coupon-push-cost less than or equal to the advertiser credit account balance.

11. The method of claim 1, further comprising the step of subtracting a coupon redemption amount from the advertiser credit account associated with the coupon when the coupon is redeemed or after the coupon is redeemed.

12. A method of distributing an electronic coupon in response to a request from a user using a computer network, comprising:
maintaining a database including one or more coupon campaign records associated with one or more advertisers, wherein the coupon campaign record is associated with an advertiser credit amount;
receiving a coupon request from an indicating user for a coupon associated with a coupon record in the database via the computer network;
providing to the indicating user the coupon corresponding to the coupon request;
subtracting a coupon redemption amount from the advertiser credit account associated with the coupon when the coupon is redeemed.

13. The method of claim 12, comprising the step of subtracting a coupon distribution amount from the advertiser credit amount associated with the coupon provided.

14. A system for enabling an advertiser using a computer network to distribute a coupon comprising:
a computer system having stored thereon
a database having at least one account record for each of a plurality of advertisers using the computer network, the account record including:
at least one coupon record having a coupon and a coupon identifier;
an account balance;
payment processing information, wherein said payment processing information is accessible to the computer system and isolated from public access via the computer network; and
a payment history;
programming code on the computer system for providing the advertiser with login access in response to authentication, wherein the advertiser's login access grants the advertiser access to modify the advertiser's account, the advertiser not being provided with access to modify the accounts of others;
programming code on the computer system for adding money to the account of an advertiser in substantially real time upon receiving a request from said advertiser;
programming code on said computer system for adding a coupon to an account of an advertiser in substantially real time upon receiving a request from said advertiser;
programming code on said computer system for deactivating a coupon related to an account of an advertiser in substantially real time upon receiving a request from said advertiser;
programming code on said computer system for modifying in substantially real time a coupon listing of an advertiser upon receiving a request from said advertiser;
programming code on the computer system for generating in substantially real time an activity report for an advertiser receiving a request from said advertiser;
programming code on the computer system for receiving a coupon request from an indicating user for a coupon associated with a coupon record in the database, the coupon request being received over the computer network from a remote computer;
programming code on the computer system for subtracting a coupon distribution amount from the account balance of the advertiser associated with the coupon to be distributed; and
programming code on the computer system for distributing the coupon corresponding to the coupon request of the indicating user over the computer network.

15. The system of claim 14, wherein the programming code for receiving a coupon request, comprises,
programming code on the computer system for receiving indicating user location information from the indicating user;
programming code on the computer system for querying the database to retrieve a coupon result set of coupon records associated with a location value representing a geographic location within a predefined distance from the geographic location represented by the indicating user location information;
programming code on the computer system for providing the coupon result set to the indicating user; and
programming code for receiving from the user a selection of one or more coupons of the coupon result set.

16. The system of claim 14, wherein programming code for distributing the coupon corresponding to the coupon request comprises programming code on the computer system for distributing to one or more recipients designated by the indicating user a coupon corresponding to the coupon request.

17. The system of claim 16, wherein the programming code for subtracting a coupon distribution amount comprises
programming code on the computer system for calculating a total coupon-push-cost by multiplying of number of recipients times a unit coupon price, wherein the coupon distribution amount is the total coupon-push-cost.

18. The system of claim 16, comprising programming code on the computer system for subtracting a coupon distribution amount from the account balance of the advertizing user associated with the distributed coupon.

19. A system for enabling an advertiser using a computer network to distribute a coupon comprising:
a computer system having:
a processor;
a memory signal connected to the processor; the memory having at least one coupon record associated with an advertiser and an advertiser account balance, the coupon records having a coupon and a coupon identifier; the memory capable of storing function instructions executable by the processor;
an authentication function stored on the memory for providing the advertiser with login access in response to authentication, wherein the advertiser's login access grants the advertiser access to modify the advertiser's account;
an add money function stored on the memory for adding money to the account of an advertiser in substantially real time upon receiving a request from said advertiser;
an add coupon function stored on the memory for adding a coupon to an account of an advertiser upon receiving a request from said advertiser;
a request receiving function stored on the memory for receiving a coupon request from an indicating user for a coupon associated with a coupon record in the database, the coupon request being received over the computer network from the remote computer through an interface that is publicly accessible without authentication;
an account debit function stored on the memory for subtracting a coupon distribution amount from the account balance of the advertizing user associated with the coupon to be distributed;
a coupon distribution function stored on the memory for distributing the coupon corresponding to the coupon request of the indicating user over the computer network;
a coupon deactivation function stored on the memory for deactivating a coupon related to an account of an advertiser;
an advertising user account redemption debit function stored on the memory for subtracting a coupon redemption amount from the advertiser credit account associated with the coupon when the coupon is redeemed or after the coupon is redeemed.

20. The system of claim 19, wherein the request receiving function comprises,
a location determination function for receiving indicating user location information from the indicating user;
a coupon result set query function for querying the database to retrieve a coupon result set of coupon records associated with a location value representing a geographic location within a predefined distance from the geographic location represented by the indicating user location information;
a coupon result set display transmission function for providing the coupon result set to the indicating user; and
a coupon selection receiving function for receiving from the user a selection of one or more coupons of the coupon result set.

21. A system for enabling an advertiser using a computer network to distribute a coupon comprising:
a computer system having:
a processor;
a memory signal connected to the processor; the memory having at least one coupon record and at least one user record; coupon record is associated with an advertiser; the indicating user record is associated with an indicating user and an indicating user account balance; the coupon record having a coupon and a coupon identifier; the memory capable of storing function instructions executable by the processor;
an authentication function stored on the memory for providing the indicating user with login access in response to authentication, wherein the indicating user login access grants the indicating user access to modify the indicating user's account;
an indicating user add money function stored on the memory for adding money to the account of an indicating user in substantially real time upon receiving a request from said indicating user;
an add coupon function stored on the memory for adding a coupon to an account of an advertiser upon receiving a request from said advertiser;
a request receiving function stored on the memory for receiving a coupon request from an indicating user for a coupon associated with a coupon record in the database, the coupon request being received over the computer network from the remote computer through an interface;
an indicating user account debit function stored on the memory for subtracting a indicating user coupon distribution amount from the account balance of the indicating user associated with the coupon request; and
a coupon distribution function stored on the memory for distributing the coupon corresponding to the coupon request of the indicating user over the computer network.

22. The system of claim 21 wherein each coupon record is associated with an advertiser account balance; and the system comprising,
an advertiser add money function stored on the memory for adding money to the account of an advertiser in substantially real time upon receiving a request from said advertiser;
an advertiser account debit function stored on the memory for subtracting a advertiser coupon distribution amount from the account balance of the advertising user associated with the coupon to be distributed; and
an advertising user account redemption debit function stored on the memory for subtracting a coupon redemption amount from the advertiser credit account associated with the coupon when the coupon is redeemed or after the coupon is redeemed.
